(19) United States
(12) Patent Application Publication
(10) Pub. No.: US 2025/0391065 A1
(43) Pub. Date: Dec. 25, 2025

(54) SKIN TONE MODIFICATION IN DIGITAL IMAGES

(71) Applicant: Motorola Mobility LLC, Chicago, IL (US)

(72) Inventors: Amit Kumar Agrawal, Bangalore (IN); Rahul Bharat Desai, Hoffman Estates, IL (US)

(73) Assignee: Motorola Mobility LLC, Chicago, IL (US)

(21) Appl. No.: 18/751,133

(22) Filed: Jun. 21, 2024

(51) Int. Cl. G06T 11/00; G06T 7/90; G06V 10/94; G06V 40/10

(52) U.S. Cl. CPC G06T 11/001; G06T 7/90; G06V 10/945; G06V 40/10; G06T 2207/10024; G06T 2207/20092; G06T 2207/30196

(57) ABSTRACT

Techniques for skin tone modification in digital images are described. For instance, the described techniques can be implemented to detect that input user skin tone data in a digital image exceeds a threshold variation from target skin tone data associated with a user profile. The input user skin tone data can be modified based at least in part on the target skin tone data to generate modified user skin tone data for the digital image.

### BACKGROUND

Today's person is afforded a tremendous selection of devices that are capable of performing a multitude of tasks. For instance, desktop and laptop computers provide computing power and screen space for productivity and entertainment tasks. Further, smartphones and tablets provide computing power and communication capabilities in highly portable form factors. One particularly useful task involves the capture of digital images of users, such as still images, video images, etc.

### BRIEF DESCRIPTION OF THE DRAWINGS

Aspects of skin tone modification in digital images are described with reference to the following Figures. The same numbers may be used throughout to reference similar features and components that are shown in the Figures. Further, identical numbers followed by different letters reference different instances of features and components described herein:

FIG. 1 illustrates an example environment 100 in which aspects of skin tone modification in digital images can be implemented.

FIG. 2 illustrates a system 200 for implementing aspects of skin tone modification in digital images in accordance with aspects of the present disclosure.

FIG. 3 illustrates a system 300 for implementing aspects of skin tone modification in digital images in accordance with aspects of the present disclosure.

FIG. 4 illustrates a scenario 400 for implementing aspects of skin tone modification in digital images in accordance with aspects of the present disclosure.

FIG. 5 illustrates a flow chart depicting an example method 500 for skin tone modification in digital images in accordance with one or more implementations.

FIG. 6 illustrates a flow chart depicting an example method 600 for skin tone modification in digital images in accordance with one or more implementations.

FIG. 7 illustrates a flow chart depicting an example method 700 for skin tone modification in digital images in accordance with one or more implementations.

FIG. 8 illustrates a flow chart depicting an example method 800 for skin tone modification in digital images in accordance with one or more implementations.

FIG. 9 illustrates various components of an example device 900 in which aspects of skin tone modification in digital images can be implemented.

### DETAILED DESCRIPTION

Techniques for skin tone modification in digital images are described. For instance, the described techniques can be implemented to modify user images in digital images to attempt to match target skin tones.

As an example, consider a scenario where a digital image (e.g., a digital photograph, a digital video) includes multiple human images for multiple different persons. In some conventional image editing scenarios, an image editor may apply color correction to the digital image based on various visual features of the digital image, such as to white balance the digital image as a whole and/or based on a skin tone of a person that is most visually prominent in the digital image. For instance, a skin tone of an image of a person that is closest to a center of the digital image and/or a largest human image in the digital image may be used to apply color correction and skin tone modification to all human images in the digital image. However, such color correction implementations may cause undesirable skin tone modification to some human images in the digital image.

Accordingly, techniques described in the present disclosure enable skin tone modification to be applied to individual user images within a digital image, such as based on identification of individual persons that are detected as viewing a digital image and/or are identified within the digital image. For instance, in a digital image in which multiple human images are present, a target user image can be identified for skin tone modification processing. The target user image can be identified in different ways, such as based on a user that is detected as viewing the digital image and/or a user profile of a user associated with a client device on which the digital image is displayed. A camera of the client device, for example, can capture a live image of the target user and match the live image to a user profile, such as based on image recognition and image matching to a target user associated a user profile.

Further, target skin tone data for the target user image can be used to determine whether and/or how to apply skin tone modification to the target user image. The target skin tone data, for instance, represents a preferred visual skin tone for the target user. As further detailed in this disclosure, the target skin tone data can be generated based on observed user behaviors pertaining to digital images that include images of the target user and/or user indicated preference for a particular skin tone appearance.

Accordingly, the target user image in the digital image can be processed to determine whether a skin tone of the target user image correlates to a skin tone of the target skin tone data. For instance, the system can compare the skin tone of the target user image to the target skin tone data to determine whether the skin tone of the target user exceeds a threshold variation from the target skin tone data. If the skin tone of the target user exceeds the threshold variation from the target skin tone data, skin tone modification can be applied to the target user image to cause the skin tone of the target user image to more closely match the target skin tone data. The modified target user image can be included in the original digital image to enable a user preferred skin tone appearance for the target user in the digital image.

Various aspects of implementations described herein can leverage artificial intelligence (AI) functionality (e.g., AI and/or machine learning algorithms, AI and/or machine learning models, etc.) to detect user appearance variations and to generate modified user appearance. As discussed herein, the terms “AI” and “machine learning” can be used to refer to machine-implemented intelligence for performing various tasks on data, such as data analysis, data classification, data modification, data generation, etc. For instance, AI functionality can be used for skin tone classification, such as to determine whether skin tone data for input user image data for a target user exceeds a threshold variation from target skin tone data for the target user. Further, AI functionality can be used to visually modify skin tone data of input user image data and/or to generate skin tone data that more closely visually resembles target skin tone data. The described implementations can utilize different types of AI models, such as classifier models, generative models, prediction models, combinations thereof, etc.

Accordingly, the described techniques can provide improvements to color modification in digital images, such as to automatically detect variations from target skin tones and to apply skin tone modifications to user images within digital images.

While features and concepts of skin tone modification in digital images can be implemented in any number of environments and/or configurations, aspects the described techniques are described in the context of the following example systems, devices, and methods. Further, the systems, devices, and methods described herein are interchangeable in various ways to provide for a wide variety of implementations and operational scenarios.

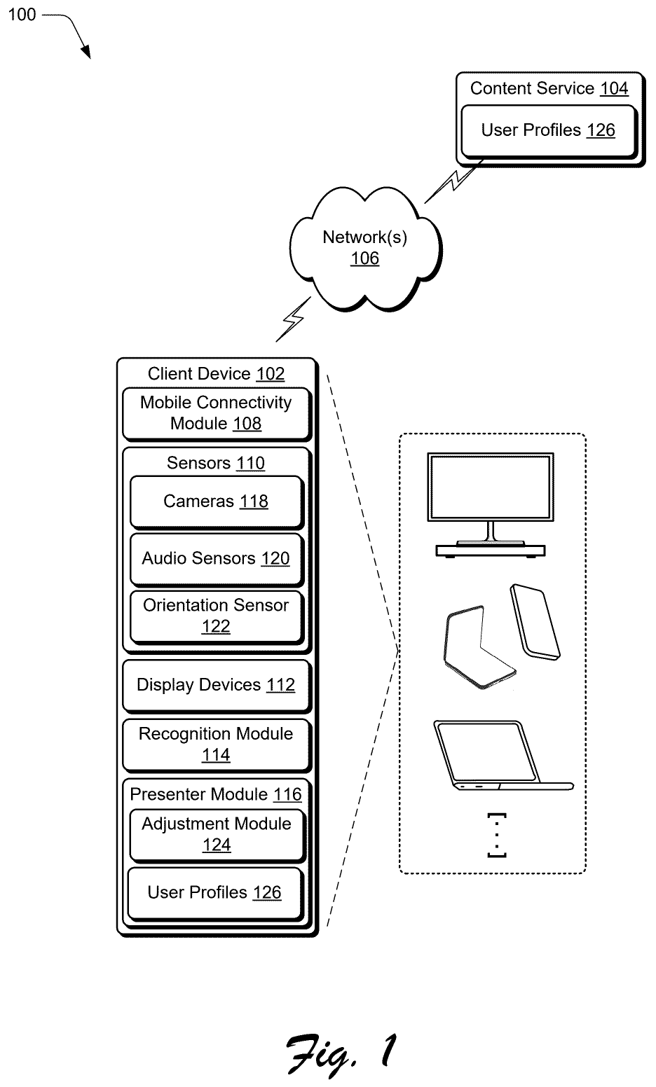

FIG. 1 illustrates an example environment 100 in which aspects of skin tone modification in digital images can be implemented. The environment 100 includes a client device 102 and a content service 104 that are interconnectable via network(s) 106. The client device 102 can be implemented in various ways, such as a mobile device (e.g., a smartphone), a mobile foldable device (e.g., a foldable smartphone, a foldable tablet device), a laptop computing device, a desktop computing device, a wearable computing device (e.g., smart glasses), and so forth. Example attributes of the client device 102 are discussed below with reference to the device 900 of FIG. 9.

The client device 102 includes various functionality that enables the client device 102 to perform different aspects of skin tone modification in digital images discussed herein, including a mobile connectivity module 108, sensors 110, display devices 112, a recognition module 114, and a presenter module 116. The mobile connectivity module 108 represents functionality (e.g., logic and hardware) for enabling the client device 102 to interconnect with other devices and/or networks, such as the network 106. The mobile connectivity module 108, for instance, enables wireless and/or wired connectivity of the client device 102.

The sensors 110 are representative of functionality to detect various physical and/or logical phenomena in relation to the client device 102, such as motion, light, image detection and recognition, time and date, position, location, touch detection, sound, temperature, and so forth. Examples of the sensors 110 include hardware and/or logical sensors such as an accelerometer, a gyroscope, a camera, a microphone, a clock, biometric sensors, touch input sensors, position sensors, environmental sensors (e.g., for temperature, pressure, humidity, and so on), geographical location information sensors (e.g., Global Positioning System (GPS) functionality), and so forth. In this particular example the sensors 110 include cameras 118, audio sensors 120, and an orientation sensor 122. The sensors 110, however, can include a variety of other sensor types in accordance with the implementations discussed herein.

The display devices 112 represent functionality for outputting visual content via the client device 102. In at least some implementations the client device 102 includes multiple display devices 112 that can be leveraged for outputting content. The recognition module 114 represents functionality for recognizing objects detected by the sensors 110. For instance, utilizing video data captured by the cameras 118, the recognition module 114 can recognize visual objects present in the video data, such as human images and other visual objects. Various other types of sensor data may additionally or alternatively be used, such as audio data captured by the audio sensors 120. The presenter module 116 represents functionality for performing various aspects pertaining to skin tone modification in digital images in accordance with various implementations. For instance, and as further detailed below, the presenter module 116 is operable to configure and/or adapt a visual appearance (e.g., skin tone) of digital images output by the client device 102.

The presenter module 116 includes an adjustment module 124 and maintains and/or has access to user profiles 126 which represent various information (e.g., data) about users associated with the client device 102. The adjustment module 124 represents functionality to enable the presenter module 116 to perform various aspects of skin tone modification in digital images described herein, such as to perform skin tone adjustment on user images within digital images. The user profiles 126 include data that represents visual attributes of different users, such as target skin tone data that describes a “ground truth” skin tone for individual users. As further described herein, for instance, the user profiles 126 can be utilized to modify a visual appearance of a user, such as a skin tone of the user in a digital image.

The content service 104 may also maintain and/or have access to user profiles 126, implementations of which are described above. For instance, the content service 104 may utilize the user profiles 126 to perform various aspects of skin tone modification in digital images described herein.

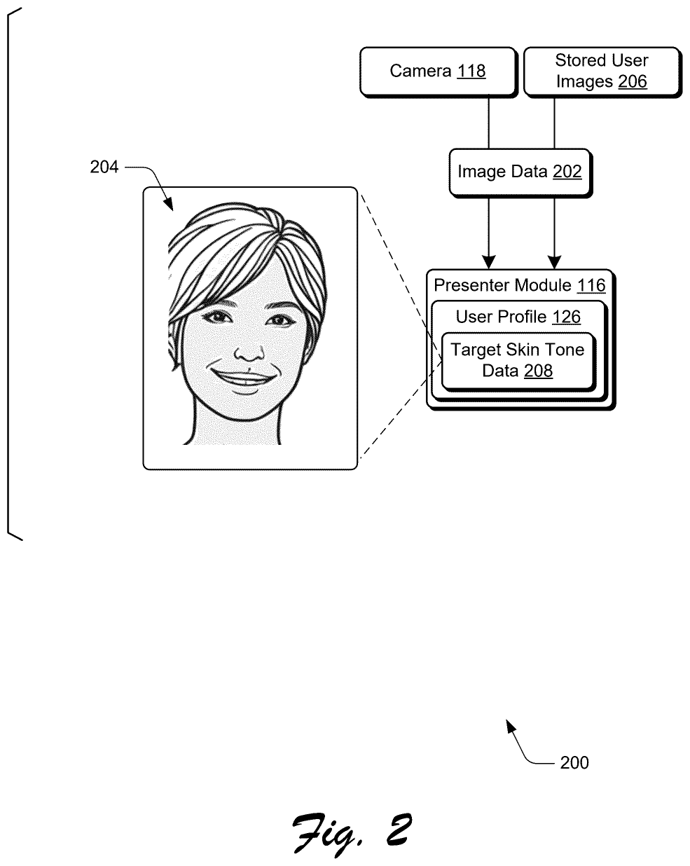

FIG. 2 illustrates a system 200 for implementing aspects of skin tone modification in digital images in accordance with aspects of the present disclosure. In the system 200 the presenter module 116 receives image data 202 for a user 204, such as from a camera 118 and/or stored user images 206. The image data 202, for instance, includes digital images (e.g., still digital images, digital video, etc.) in which an image of the user 204 is present. The presenter module 116 generates and/or updates a user profile 126 for the user 204 to include target skin tone data 208 for the user 204. Further, the user profile 126 can include one or more reference user images for the user 204 to enable visual recognition of the user 204 in digital images.

In implementations, the target skin tone data 208 represents a “ground truth” skin tone appearance for the user 204, e.g., a skin tone appearance preferred by the user 204. The target skin tone data 208 can be generated in various ways, such as based on observed user behaviors pertaining to digital images that include images of the user 204 that indicate a preference for a visual appearance of the target skin tone data 208. As described throughout this disclosure, the target skin tone data 208 can be utilized for modification of digital user images of the user 204.

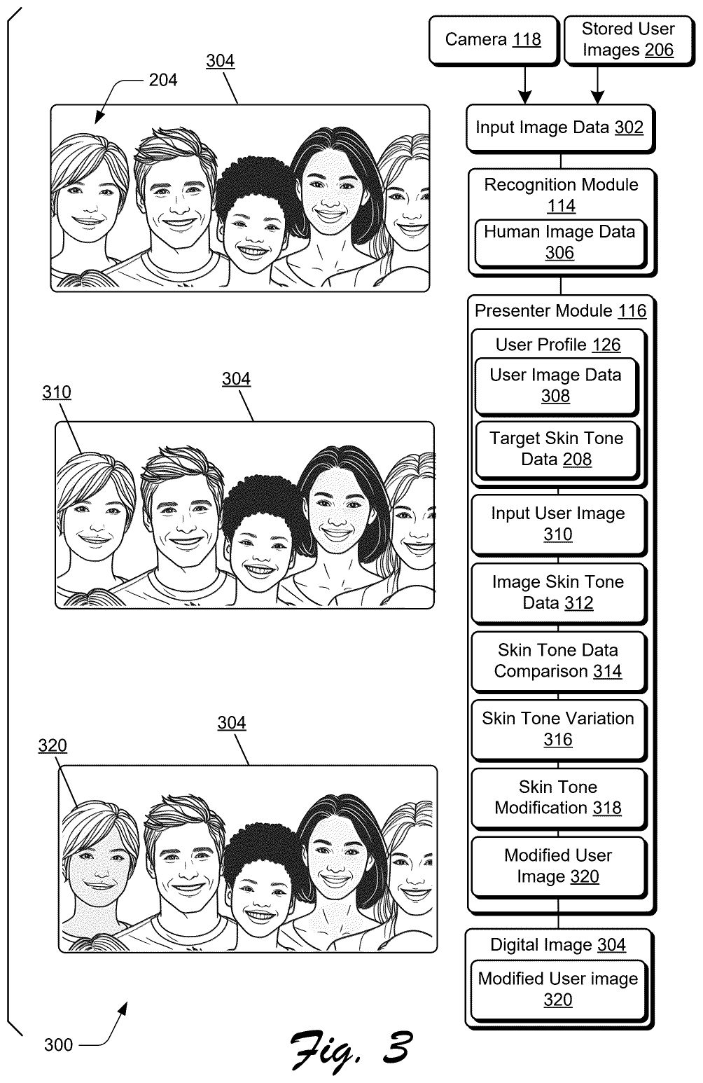

FIG. 3 illustrates a system 300 for implementing aspects of skin tone modification in digital images in accordance with aspects of the present disclosure. In the system 300 input image data 302 is received for a digital image 304, such as via a camera 118 and/or stored user images 206. The input image data 302 includes a user image of the user 204. The recognition module 114 processes the input image data 302 to recognize different human images within the digital image 304 and to generate human image data 306 for the different human images. The human image data 306, for example, tags different regions within the digital image 304 as including human images. In at least one implementation, the recognition module 114 can utilize an AI model for processing the input image data 302 and for generating the human image data 306, such as an AI classifier model.

In at least one implementation the input image data 302 is captured by a camera 118 and indicates that the user 204 is positioned (e.g., in a physical position) to view the digital image 304, such as via the client device 102. For instance, the input image data 302 can include a live real time image of the user gazing at a display device 112 on which the digital image 304 is displayed. Thus, implementations described herein can be employed to perform skin tone processing based on a current user (e.g., the user 204) that is detected as being positioned to view a digital image, e.g., the digital image 304.

Further to the system 300, the presenter module 116 receives the human image data 306 and matches user image data 308 from the human image data 306 to a user profile 126 for the user 204. The user profile 126, for instance, includes digital visual attributes of the user 204, such as facial features and/or other human features of the user 204, e.g., body shape, body proportions, etc. Facial features identified in the human image data 306, for instance, can be matched to facial features identified in the user profile 126 to match an image of the user 204 in the digital image 304 to the user 204 associated with the user profile 126. Accordingly, the presenter module 116 identifies an input user image 310 of the user 204 within the digital image 304. For example, the presenter module 116 can differentiate the input user image 310 from other human images within the digital image 304, such as for applying skin tone processing to the input user image 310.

The user profile 126 also includes target skin tone data 208 for the user 204, e.g., preferred and/or defined skin tone data that describes a target skin tone for the user 204 in digital images. The presenter module 116 determines image skin tone data 312 for the input user image 310 in the digital image 304 and performs skin tone data comparison 314 of the image skin tone data 312 to the target skin tone data 208.

In implementations the target skin tone data 208 can be implemented as a target color value (e.g., hue value) and/or set of target color values in a particular color space, such as a red green blue (RGB) color space, a cyan, magenta, yellow, and key (CMYK) color space, a CIE 1931 color space, etc. In an example the target skin tone data 208 can be generated as an average color value, such as generated from image data 202. Further, the image skin tone data 312 can be determined from the input user image 310 as an input color value and/or set of input color values in a particular color space, such as a color space used to define the target skin tone data 208. Thus, the skin tone data comparison 314 can be performed by comparing one or more input color values of the image skin tone data 312 to one or more target color values of the target skin tone data 208.

Further to the system 300 and based at least in part on the skin tone data comparison 314, the presenter module 116 identifies a skin tone variation 316 between the image skin tone data 312 of the input user image 310 and the target skin tone data 208. The presenter module 116, for instance, determines that a color value of the image skin tone data 312 various a threshold amount (e.g., a threshold number of color values) from a target color value of the target skin tone data 208.

Accordingly, the presenter module 116 performs a skin tone modification 318 on the input user image 310 to generate a modified user image 320. The adjustment module 124 of the presenter module 116, for example, performs color modification of the input user image 310 to more closely match the target skin tone data 208. In at least one implementation, as part of the skin tone modification 318, the adjustment module 124 modifies input color values of the input user image 310 to match target color values of the target skin tone data 208 to generate the modified user image 320. The presenter module 116 can then cause the modified user image 320 to be output as part of the digital image 304, e.g., to modify and/or replace the input user image 310 in the digital image 304.

While the systems 200, 300 are discussed with reference to skin tone processing for an individual user image, it is to be appreciated that techniques described in the present disclosure can be applied to multiple different user images, such as multiple user images within a single digital image. For instance, multiple user profiles 126 for different persons can be generated that each include respective target skin tone data 208. Thus, the target skin tone data 208 for each respective person can be applied to skin tones of respective user images within a single digital image to generate modified user images for each user. Each user image within the digital image, for instance, can be separately processed to individually modify the skin tone appearance of the user image and generate separate modified skin tones for different individual users within the digital image.

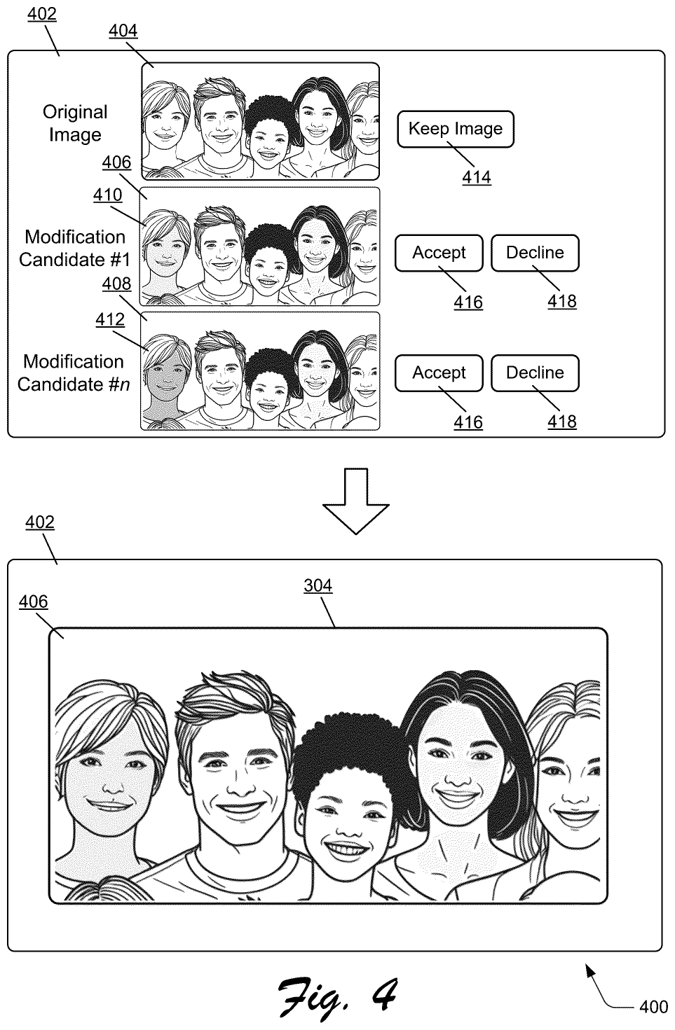

FIG. 4 illustrates a scenario 400 for implementing aspects of skin tone modification in digital images in accordance with aspects of the present disclosure. Operations and/or aspects of the scenario 400 can be implemented by various functionality described herein, such as the presenter module 116 and/or the content service 104. The scenario 400 includes a graphical user interface (GUI) 402 that includes different versions of the digital image 304 including an original digital image 404, a first modification candidate 406, and a second modification candidate 408. The original digital image 404, for instance, represents the digital image 304 without image modification, e.g., without image processing applied such as depicted in the system 300. The first modification candidate 406 and the second modification candidate 408 represent the digital image 304 with image modification applied, such as depicted in the system 300.

The first modification candidate 406 includes a first modified user image 410 of the user 204 and the second modification candidate 408 includes a second modified user image 412 of the user 204. The first modified user image 410 and the second modified user image 412, for instance, are generated via skin tone modification 318. Further, the first modified user image 410 and the second modified user image 412 each have different applied skin tone modifications. For instance, the first modified user image 410 has a different color value adjustment applied than the second modified user image 412.

The original digital image 404 is associated with a keep control 414 which is selectable to maintain the digital image 304 in an unmodified state. For instance, user selection of the keep control 414 stores the original digital image 404 (e.g., the digital image 304) without image modification applied to the user image.

The first modification candidate 406 and the second modification candidate 408 are each associated with a respective accept control 416 and a respective decline control 418. The accept controls 416 are selectable to cause one or more of the first modification candidate 406 or the second modification candidate 408 to be stored, e.g., as the digital image with the modified user image 320. The decline controls 418 are selectable to cause one or more of the first modification candidate 406 or the second modification candidate 408 to be discarded, e.g., not stored and deleted.

Further to the scenario 400, the user selects the accept control 416 of the first modification candidate 406 which causes the digital image 304 with the first modified user image 410 to be stored as a modified version of the digital image 304. Accordingly, implementations described herein can generate multiple different skin tone modification candidates (e.g., via processing described in the system 300) and can enable a user to select one or more skin tone modification candidates for storage and/or communication.

As described above, different operations of the recognition module 114 and/or the presenter module 116 can be performed using AI functionality, such as one or more AI classifier models for performing the skin tone data comparison 314 to determine skin tone variation 316, and/or one or more AI generative models to perform the skin tone modification 318 and generate the modified user image 320.

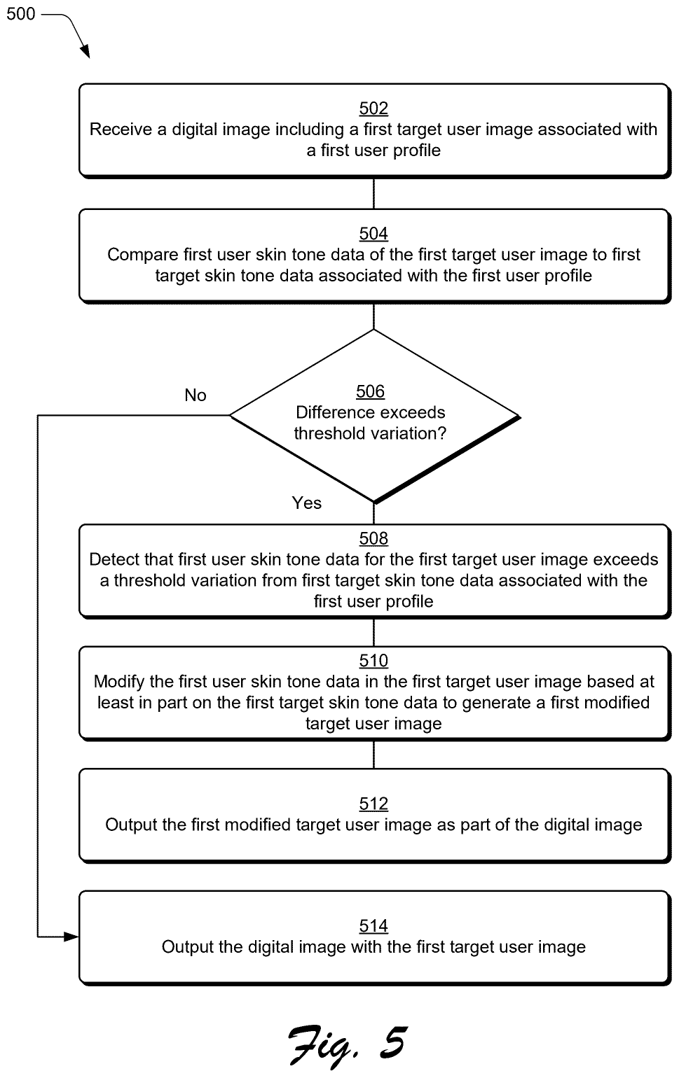

FIG. 5 illustrates a flow chart depicting an example method 500 for skin tone modification in digital images in accordance with one or more implementations. At 502 a digital image is received including a first target user image associated with a first user profile. The presenter module 116, for example, receives a digital image with a target user image associated with a user profile 126. In at least one implementation, the first target user image is tagged (e.g., by the recognition module 114) as a human image and/or an image of a target user.

At 504 first user skin tone data of the first target user image is compared to first target skin tone data associated with the first user profile. For instance, the presenter module 116 compares one or more color values for the first target user image to one or more color values of the target skin tone data. At 506 it is determined whether a difference between the first user skin tone data of the first target user image and the target skin tone data exceeds a threshold variation. The presenter module 116, for instance, determines whether a difference between one or more color values of the skin tone data of the first target user image exceeds a threshold difference from one or more color values of the target skin tone data. In at least one implementation the threshold difference can be defined in terms of a number of color values. For instance, in an RGB space implementation, the threshold difference can be defined in terms of R values, G values, and/or B values.

If the difference between the first user skin tone data of the first target user image and the first target skin tone data exceeds a threshold variation (“Yes”), at 508 it is detected that the first user skin tone data for the first target user image exceeds a threshold variation from first target skin tone data associated with the first user profile. At 510 the first user skin tone data in the first target user image is modified based at least in part on the first target skin tone data to generate a first modified target user image. The adjustment module 124, for instance, modifies color values of the first user skin tone data to more closely match color values of the first target skin tone data.

At 512 the first modified target user image is output as part of the digital image. The presenter module 116, for example, inserts the first modified target user image into the digital image, such as to replace and/or overlay the first target user image in the digital image.

Returning to 506, if the difference between the first user skin tone data of the first target user image and the first target skin tone data does not exceed the threshold variation (“No”), at 514 the digital image is output with the first target user image. The first target user image, for instance, is not visually modified, e.g., an original skin tone appearance of the first target user image is maintained in the digital image.

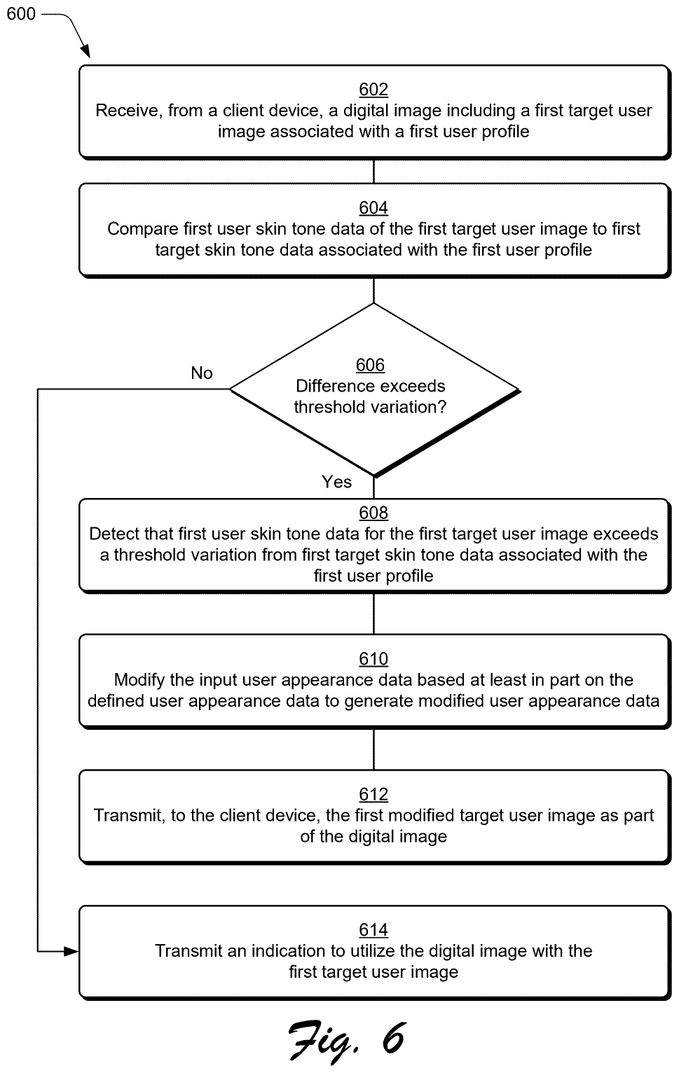

FIG. 6 illustrates a flow chart depicting an example method 600 for skin tone modification in digital images in accordance with one or more implementations. At 602 a digital image including a first target user image associated with a first user profile is received from a client device. The content service 104, for instance, receives the digital image including the first target user image from the client device 102. At 604 first user skin tone data of the first target user image is compared to first target skin tone data associated with the first user profile. For instance, the content service 104 compares one or more color values for the first target user image to one or more color values of the target skin tone data.

At 606 it is determined whether a difference between the first user skin tone data of the first target user image and the target skin tone data exceeds a threshold variation. The presenter module 116, for instance, determines whether a difference between one or more color values of the skin tone data of the first target user image exceeds a threshold difference from one or more color values of the target skin tone data. In at least one implementation the threshold difference can be defined in terms of a number of color values.

If the difference between the first user skin tone data of the first target user image and the first target skin tone data exceeds a threshold variation (“Yes”), at 608 it is detected that the first user skin tone data for the first target user image exceeds a threshold variation from first target skin tone data associated with the first user profile. At 610 the first user skin tone data in the first target user image is modified based at least in part on the first target skin tone data to generate a first modified target user image. The content service 104, for instance, modifies color values of the first user skin tone data to more closely match color values of the first target skin tone data.

At 612 the first modified target user image is transmitted to the client device as part of the digital image. The content service 104, for instance, transmits the first modified target user image and/or the digital image with the first modified target user image to the client device 102.

Returning to 606, if the difference between the first user skin tone data of the first target user image and the first target skin tone data does not exceed the threshold variation (“No”), at 614 an indication is transmitted to utilize the digital image with the first target user image. The content service 104, for instance, transmits an indication to the client device 102 to utilize the digital image including the first target user image. Alternatively or additionally the indication can specify that the first target user image is within (e.g., does not exceed) a threshold variation from the first target skin tone data. Alternatively or additionally, the content service 104 can transmit the digital image with an unmodified first target user image to the client device 102.

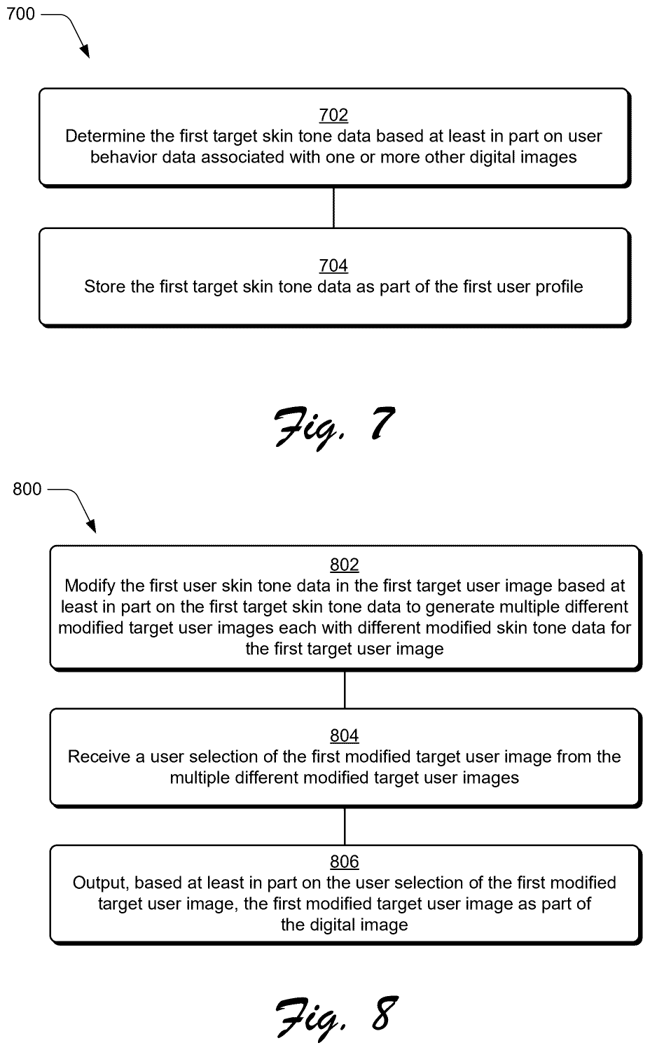

FIG. 7 illustrates a flow chart depicting an example method 700 for skin tone modification in digital images in accordance with one or more implementations. At 702 the first target skin tone data is determined based at least in part on user behavior data associated with one or more other digital images. The client device 102 and/or the content service 104, for instance, identify the first target skin tone data based at least in part on user behavior that indicates a preference for a particular skin tone appearance and/or user behavior that indicates that user does not prefer (e.g., dislikes) a particular skin tone appearance.

Examples of user behavior indicating that a user dislikes a particular skin tone appearance include user deletion of one or more other digital images, a user archive of the one or more other digital images, a user providing an unfavorable sentiment value for the one or more other digital images, etc. Examples of user behavior indicating that a user likes (e.g., prefers) a particular skin tone appearance include an indication of a user preference for the one or more other digital images, a user indication to set a digital image of the one or more other digital images as a profile digital image, a user sharing the one or more other digital images with one or more other users, a user sharing the one or more other digital images with a different user account, etc.

At 704 the first target skin tone data is stored as part of the first user profile. The first target skin tone data, for example, can be used to perform skin tone modification, such as described throughout this disclosure.

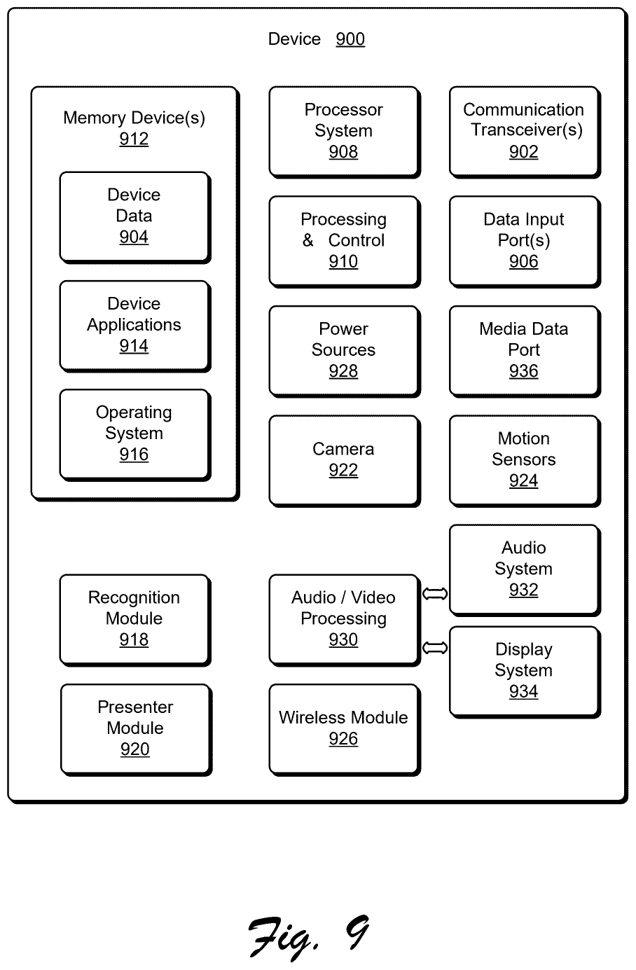

FIG. 8 illustrates a flow chart depicting an example method 800 for skin tone modification in digital images in accordance with one or more implementations. At 802 the first user skin tone data in the first target user image is modified based at least in part on the first target skin tone data to generate multiple different modified target user images each with different modified skin tone data for the first target user image. The client device 102 and/or the content service 104, for instance, generate multiple different modified target user images that each attempt to match a skin tone of the target user image to the first target skin tone data.

At 804 a user selection is received of the first modified target user image from the multiple different modified target user images. A user, for instance, selects the first modified target user image from the multiple different target user images. At 806, based at least in part on the user selection of the first modified target user image, the first modified target user image is output as part of the digital image.

The example methods described above may be performed in various ways, such as for implementing different aspects of the systems and scenarios described herein. Generally, any services, components, modules, methods, and/or operations described herein can be implemented using software, firmware, hardware (e.g., fixed logic circuitry), manual processing, or any combination thereof. Some operations of the example methods may be described in the general context of executable instructions stored on computer-readable storage memory that is local and/or remote to a computer processing system, and implementations can include software applications, programs, functions, and the like. Alternatively or in addition, any of the functionality described herein can be performed, at least in part, by one or more hardware logic components, such as, and without limitation, Field-programmable Gate Arrays (FPGAs), Application-specific Integrated Circuits (ASICs), Application-specific Standard Products (ASSPs), System-on-a-chip systems (SoCs), Complex Programmable Logic Devices (CPLDs), and the like. The order in which the methods are described is not intended to be construed as a limitation, and any number or combination of the described method operations can be performed in any order to perform a method, or an alternate method.

FIG. 9 illustrates various components of an example device 900 in which aspects of skin tone modification in digital images can be implemented. The example device 900 can be implemented as any of the devices described with reference to the previous FIGS. 1-8, such as any type of client device, mobile phone, mobile device, wearable device, tablet, computing, communication, entertainment, gaming, media playback, and/or other type of electronic device. For example, the client device 102 as shown and described with reference to FIGS. 1-8 may be implemented as the example device 900.

The device 900 includes communication transceivers 902 that enable wired and/or wireless communication of device data 904 with other devices. The device data 904 can include any of device identifying data, device location data, wireless connectivity data, and wireless protocol data. Additionally, the device data 904 can include any type of audio, video, and/or image data. Example communication transceivers 902 include wireless personal area network (WPAN) radios compliant with various IEEE 802.15 (Bluetooth™) standards, wireless local area network (WLAN) radios compliant with any of the various IEEE 802.11 (Wi-Fi™) standards, wireless wide area network (WWAN) radios for cellular phone communication, wireless metropolitan area network (WMAN) radios compliant with various IEEE 802.16 (WiMAX™) standards, and wired local area network (LAN) Ethernet transceivers for network data communication.

The device 900 may also include one or more data input ports 906 via which any type of data, media content, and/or inputs can be received, such as user-selectable inputs to the device, messages, music, television content, recorded content, and any other type of audio, video, and/or image data received from any content and/or data source. The data input ports may include USB ports, coaxial cable ports, and other serial or parallel connectors (including internal connectors) for flash memory, DVDs, CDs, and the like. These data input ports may be used to couple the device to any type of components, peripherals, or accessories such as microphones and/or cameras.

The device 900 includes a processing system 908 of one or more processors (e.g., any of microprocessors, controllers, and the like) and/or a processor and memory system implemented as a system-on-chip (SoC) that processes computer-executable instructions. The processor system may be implemented at least partially in hardware, which can include components of an integrated circuit or on-chip system, an application-specific integrated circuit (ASIC), a field-programmable gate array (FPGA), a complex programmable logic device (CPLD), and other implementations in silicon and/or other hardware. Alternatively or in addition, the device can be implemented with any one or combination of software, hardware, firmware, or fixed logic circuitry that is implemented in connection with processing and control circuits, which are generally identified at 910. The device 900 may further include any type of a system bus or other data and command transfer system that couples the various components within the device. A system bus can include any one or combination of different bus structures and architectures, as well as control and data lines.

The device 900 also includes computer-readable storage memory 912 (e.g., memory devices) that enable data storage, such as data storage devices that can be accessed by a computing device, and that provide persistent storage of data and executable instructions (e.g., software applications, programs, functions, and the like). Examples of the computer-readable storage memory 912 include volatile memory and non-volatile memory, fixed and removable media devices, non-transitory computer-readable storage media, and any suitable memory device or electronic data storage that maintains data for computing device access. The computer-readable storage memory can include various implementations of random access memory (RAM), read-only memory (ROM), flash memory, and other types of storage media in various memory device configurations. The device 900 may also include a mass storage media device.

The computer-readable storage memory 912 provides data storage mechanisms to store the device data 904, other types of information and/or data, and various device applications 914 (e.g., software applications). For example, an operating system 916 can be maintained as software instructions with a memory device and executed by the processing system 908. The device applications may also include a device manager, such as any form of a control application, software application, signal-processing and control module, code that is native to a particular device, a hardware abstraction layer for a particular device, and so on. Computer-readable storage memory 912 represents media and/or devices that enable persistent and/or non-transitory storage of information in contrast to mere signal transmission, carrier waves, or signals per se. Computer-readable storage memory 912 do not include signals per se or transitory signals.

In this example, the device 900 includes a recognition module 918 and a presenter module 920 that can implement aspects of skin tone modification in digital images and may be implemented with hardware components and/or in software as one of the device applications 914. For example, the recognition module 918 can be implemented as the recognition module 114 and the presenter module 920 can be implemented as the presenter module 116, described in detail above. In implementations, the recognition module 918 and/or the presenter module 920 may include independent processing, memory, and logic components as a computing and/or electronic device integrated with the device 900.

In this example, the example device 900 also includes a camera 922 and motion sensors 924, such as may be implemented in an inertial measurement unit (IMU). The motion sensors 924 can be implemented with various sensors, such as a gyroscope, an accelerometer, and/or other types of motion sensors to sense motion of the device. The various motion sensors 924 may also be implemented as components of an inertial measurement unit in the device.

The device 900 also includes a wireless module 926, which is representative of functionality to perform various wireless communication tasks. For instance, for the client device 102, the wireless module 926 can be leveraged to scan for and detect wireless networks, as well as negotiate wireless connectivity to wireless networks for the client device 102. The device 900 can also include one or more power sources 928, such as when the device is implemented as a mobile device. The power sources 928 may include a charging and/or power system, and can be implemented as a flexible strip battery, a rechargeable battery, a charged super-capacitor, and/or any other type of active or passive power source.

The device 900 also includes an audio and/or video processing system 930 that generates audio data for an audio system 932 and/or generates display data for a display system 934. The audio system and/or the display system may include any devices that process, display, and/or otherwise render audio, video, display, and/or image data. Display data and audio signals can be communicated to an audio component and/or to a display component via an RF (radio frequency) link, S-video link, HDMI (high-definition multimedia interface), composite video link, component video link, DVI (digital video interface), analog audio connection, or other similar communication link, such as media data port 936. In implementations, the audio system and/or the display system are integrated components of the example device. Alternatively, the audio system and/or the display system are external, peripheral components to the example device.

Although implementations of skin tone modification in digital images have been described in language specific to features and/or methods, the subject of the appended claims is not necessarily limited to the specific features or methods described. Rather, the features and methods are disclosed as example implementations, and other equivalent features and methods are intended to be within the scope of the appended claims. Further, various different examples are described and it is to be appreciated that each described example can be implemented independently or in connection with one or more other described examples. Additional aspects of the techniques, features, and/or methods discussed herein relate to one or more of the following:

In addition to the previously described methods, any one or more of the following:

In some aspects, the techniques described herein relate to a client device including: at least one memory; and at least one processor coupled with the at least one memory and configured to cause the client device to: detect that first user skin tone data for a first target user image in a digital image exceeds a threshold variation from first target skin tone data associated with a first user profile; modify the first user skin tone data in the first target user image based at least in part on the first target skin tone data to generate a first modified target user image; and output the first modified target user image as part of the digital image.

In some aspects, the techniques described herein relate to a client device, wherein the at least one processor is configured to cause the client device to: process the digital image to identify the first target user image; and tag the first target user image with a digital tag that differentiates the first target user image from one or more other person images in the digital image.

In some aspects, the techniques described herein relate to a client device, wherein the at least one processor is configured to cause the client device to identify the first target user image based at least in part on a first reference user image associated with the first user profile.

In some aspects, the techniques described herein relate to a client device, wherein the at least one processor is configured to cause the client device to: determine the first target skin tone data based at least in part on user behavior data associated with one or more other digital images; and store the first target skin tone data as part of the first user profile.

In some aspects, the techniques described herein relate to a client device, wherein the user behavior data includes one or more of user deletion of the one or more other digital images or a user archive of the one or more other digital images.

In some aspects, the techniques described herein relate to a client device, wherein the user behavior data includes one or more of an indication of a user preference for the one or more other digital images, a user indication to set a digital image of the one or more other digital images as a profile digital image, a user sharing the one or more other digital images with one or more other users, or a user sharing the one or more other digital images with a different user account.

In some aspects, the techniques described herein relate to a client device, wherein the user behavior data includes a user indication that the one or more other digital images include preferred skin tone data for the user.

In some aspects, the techniques described herein relate to a client device, wherein the at least one processor is configured to cause the client device to: modify the first user skin tone data in the first target user image based at least in part on the first target skin tone data to generate multiple different modified target user images each with different modified skin tone data for the first target user image; receive a user selection of the first modified target user image from the multiple different modified target user images; and output, based at least in part on the user selection of the first modified target user image, the first modified target user image as part of the digital image.

In some aspects, the techniques described herein relate to a client device, wherein the at least one processor is configured to cause the client device to: detect that a first user associated with the first user profile is positioned to view the digital image, and in response: detect that the first user skin tone data for the first target user image in the digital image exceeds the threshold variation from the first target skin tone data associated with the first user profile; modify the first user skin tone data in the first target user image based at least in part on the first target skin tone data to generate the first modified target user image; and output the first modified target user image as part of the digital image.

In some aspects, the techniques described herein relate to a client device, wherein the at least one processor is configured to cause the client device to: detect that a second user is positioned to view the digital image; detect that second user skin tone data for a second target user image in the digital image exceeds a threshold variation from second target skin tone data associated with a second user profile of the second user; modify the second user skin tone data in the second target user image based at least in part on the second target skin tone data to generate a second modified target user image; and output the second modified target user image as part of the digital image.

In some aspects, the techniques described herein relate to a client device, wherein the at least one processor is configured to cause the client device to: identify one or more other person images other than the first target user image in the digital image; and differentiate the first target user image from the one or more other person images for skin tone modification processing.

In some aspects, the techniques described herein relate to a client device, wherein the at least one processor is configured to cause the client device to: tag the one or more other person images as one or more second target user images; detect that second user skin tone data for the one or more second target user images exceeds a threshold variation from second target skin tone data associated with one or more second user profiles; modify the second user skin tone data in the one or more second target user images based at least in part on the second target skin tone data to generate one or more second modified target user images; and output the one or more second modified target user images as part of the digital image.

In some aspects, the techniques described herein relate to a method performed by a client device, the method including: detecting that first user skin tone data for a first target user image in a digital image exceeds a threshold variation from first target skin tone data associated with a first user profile; modifying the first user skin tone data in the first target user image based at least in part on the first target skin tone data to generate a first modified target user image; and outputting the first modified target user image as part of the digital image.

In some aspects, the techniques described herein relate to a method, further including determining the first target skin tone data based at least in part on user behavior data associated with one or more other digital images, the user behavior data including one or more of user deletion of the one or more other digital images, a user archive of the one or more other digital images, an indication of a user preference for the one or more other digital images, a user indication to set a digital image of the one or more other digital images as a profile digital image, a user sharing the one or more other digital images with one or more other users, or a user sharing the one or more other digital images with a different user account.

In some aspects, the techniques described herein relate to a system including: at least one memory; and at least one processor coupled to the at least one memory and configured to cause the system to: receive a digital image including a first target user image associated with a first user profile; detect that first user skin tone data for the first target user image exceeds a threshold variation from first target skin tone data associated with the first user profile; modify the first user skin tone data in the first target user image based at least in part on the first target skin tone data to generate a first modified target user image; and transmit the first modified target user image as part of the digital image.

In some aspects, the techniques described herein relate to a system, wherein the at least one processor is configured to cause the system to: determine the first target skin tone data based at least in part on user behavior data associated with one or more other digital images; and store the first target skin tone data as part of the first user profile.

In some aspects, the techniques described herein relate to a system, wherein the user behavior data includes one or more of user deletion of the one or more other digital images or a user archive of the one or more other digital images.

In some aspects, the techniques described herein relate to a system, wherein the user behavior data includes one or more of an indication of a user preference for the one or more other digital images, a user indication to set a digital image of the one or more other digital images as a profile digital image, a user sharing the one or more other digital images with one or more other users, a user sharing the one or more other digital images with a different user account, or a user indication that the one or more other digital images include preferred skin tone data for the user.

In some aspects, the techniques described herein relate to a system, wherein the at least one processor is configured to cause the system to: receive an indication that a first user associated with the first user profile is positioned to view the digital image, and in response: detect that the first user skin tone data for the first target user image in the digital image exceeds the threshold variation from the first target skin tone data associated with the first user profile; and modify the first user skin tone data in the first target user image based at least in part on the first target skin tone data to generate the first modified target user image.

In some aspects, the techniques described herein relate to a system, wherein the at least one processor is configured to cause the system to: tag one or more other person images detected in the digital image as one or more second target user images; detect that second user skin tone data for the one or more second target user images exceeds a threshold variation from second target skin tone data associated with one or more second user profiles; modify the second user skin tone data in the one or more second target user images based at least in part on the second target skin tone data to generate one or more second modified target user images; and transmit the one or more second modified target user images as part of the digital image.

What is claimed is:

1. A client device comprising:
at least one memory; and
at least one processor coupled with the at least one memory and configured to cause the client device to:
detect that first user skin tone data for a first target user image in a digital image exceeds a threshold variation from first target skin tone data associated with a first user profile;
modify the first user skin tone data in the first target user image based at least in part on the first target skin tone data to generate a first modified target user image; and
output the first modified target user image as part of the digital image.

2. The client device of claim 1, wherein the at least one processor is configured to cause the client device to:
process the digital image to identify the first target user image; and
tag the first target user image with a digital tag that differentiates the first target user image from one or more other person images in the digital image.

3. The client device of claim 2, wherein the at least one processor is configured to cause the client device to identify the first target user image based at least in part on a first reference user image associated with the first user profile.

4. The client device of claim 1, wherein the at least one processor is configured to cause the client device to:
determine the first target skin tone data based at least in part on user behavior data associated with one or more other digital images; and
store the first target skin tone data as part of the first user profile.

5. The client device of claim 4, wherein the user behavior data comprises one or more of user deletion of the one or more other digital images or a user archive of the one or more other digital images.

6. The client device of claim 4, wherein the user behavior data comprises one or more of an indication of a user preference for the one or more other digital images, a user indication to set a digital image of the one or more other digital images as a profile digital image, a user sharing the one or more other digital images with one or more other users, or a user sharing the one or more other digital images with a different user account.

7. The client device of claim 4, wherein the user behavior data comprises a user indication that the one or more other digital images include preferred skin tone data for the user.

8. The client device of claim 1, wherein the at least one processor is configured to cause the client device to:
modify the first user skin tone data in the first target user image based at least in part on the first target skin tone data to generate multiple different modified target user images each with different modified skin tone data for the first target user image;
receive a user selection of the first modified target user image from the multiple different modified target user images; and
output, based at least in part on the user selection of the first modified target user image, the first modified target user image as part of the digital image.

9. The client device of claim 1, wherein the at least one processor is configured to cause the client device to:
detect that a first user associated with the first user profile is positioned to view the digital image, and in response:
detect that the first user skin tone data for the first target user image in the digital image exceeds the threshold variation from the first target skin tone data associated with the first user profile;
modify the first user skin tone data in the first target user image based at least in part on the first target skin tone data to generate the first modified target user image; and
output the first modified target user image as part of the digital image.

10. The client device of claim 1, wherein the at least one processor is configured to cause the client device to:
detect that a second user is positioned to view the digital image;
detect that second user skin tone data for a second target user image in the digital image exceeds a threshold variation from second target skin tone data associated with a second user profile of the second user;
modify the second user skin tone data in the second target user image based at least in part on the second target skin tone data to generate a second modified target user image; and
output the second modified target user image as part of the digital image.

11. The client device of claim 1, wherein the at least one processor is configured to cause the client device to:
identify one or more other person images other than the first target user image in the digital image; and
differentiate the first target user image from the one or more other person images for skin tone modification processing.

12. The client device of claim 11, wherein the at least one processor is configured to cause the client device to:
tag the one or more other person images as one or more second target user images;
detect that second user skin tone data for the one or more second target user images exceeds a threshold variation from second target skin tone data associated with one or more second user profiles;
modify the second user skin tone data in the one or more second target user images based at least in part on the second target skin tone data to generate one or more second modified target user images; and
output the one or more second modified target user images as part of the digital image.

13. A method performed by a client device, the method comprising:
detecting that first user skin tone data for a first target user image in a digital image exceeds a threshold variation from first target skin tone data associated with a first user profile;
modifying the first user skin tone data in the first target user image based at least in part on the first target skin tone data to generate a first modified target user image; and
outputting the first modified target user image as part of the digital image.

14. The method of claim 13, further comprising determining the first target skin tone data based at least in part on user behavior data associated with one or more other digital images, the user behavior data comprising one or more of user deletion of the one or more other digital images, a user archive of the one or more other digital images, an indication of a user preference for the one or more other digital images, a user indication to set a digital image of the one or more other digital images as a profile digital image, a user sharing the one or more other digital images with one or more other users, or a user sharing the one or more other digital images with a different user account.

15. A system comprising:
at least one memory; and
at least one processor coupled to the at least one memory and configured to cause the system to:
receive a digital image including a first target user image associated with a first user profile;
detect that first user skin tone data for the first target user image exceeds a threshold variation from first target skin tone data associated with the first user profile;
modify the first user skin tone data in the first target user image based at least in part on the first target skin tone data to generate a first modified target user image; and
transmit the first modified target user image as part of the digital image.

16. The system of claim 15, wherein the at least one processor is configured to cause the system to:
determine the first target skin tone data based at least in part on user behavior data associated with one or more other digital images; and
store the first target skin tone data as part of the first user profile.

17. The system of claim 16, wherein the user behavior data comprises one or more of user deletion of the one or more other digital images or a user archive of the one or more other digital images.

18. The system of claim 16, wherein the user behavior data comprises one or more of an indication of a user preference for the one or more other digital images, a user indication to set a digital image of the one or more other digital images as a profile digital image, a user sharing the one or more other digital images with one or more other users, a user sharing the one or more other digital images with a different user account, or a user indication that the one or more other digital images include preferred skin tone data for the user.

19. The system of claim 15, wherein the at least one processor is configured to cause the system to:
receive an indication that a first user associated with the first user profile is positioned to view the digital image, and in response:
detect that the first user skin tone data for the first target user image in the digital image exceeds the threshold variation from the first target skin tone data associated with the first user profile; and
modify the first user skin tone data in the first target user image based at least in part on the first target skin tone data to generate the first modified target user image.

20. The system of claim 15, wherein the at least one processor is configured to cause the system to:
tag one or more other person images detected in the digital image as one or more second target user images;
detect that second user skin tone data for the one or more second target user images exceeds a threshold variation from second target skin tone data associated with one or more second user profiles;
modify the second user skin tone data in the one or more second target user images based at least in part on the second target skin tone data to generate one or more second modified target user images; and
transmit the one or more second modified target user images as part of the digital image.
